(19) United States
(12) Patent Application Publication
(10) Pub. No.: US 2023/0003298 A1
(43) Pub. Date: Jan. 5, 2023

(54) Integration of a Transmission Actuator

(71) Applicant: KNORR-BREMSE Systeme fuer Nutzfahrzeuge GmbH, Muenchen (DE)

(72) Inventor: Daniel GEIS-ESSER, Muenchen (DE)

(21) Appl. No.: 17/779,853

(22) PCT Filed: Nov. 11, 2020
(86) PCT No.: PCT/EP2020/081686

§ 371 Date: May 25, 2022

(30) Foreign Application Priority Data
Nov. 26, 2019 (DE) 10 2019 131 935.8

(51) Int. Cl. F16H 63/30; F16H 63/04

(52) U.S. Cl. CPC F16H 63/3013; F16H 63/04; F16H 63/3016

(57) ABSTRACT

A transmission actuator, a transfer mechanism, a system, a transmission, a drivetrain and a vehicle includes a transmission gear change arrangement in which the actuating direction of the transmission actuator is inclined in relative to a transmission shaft axis by an angle.

### BACKGROUND AND SUMMARY OF THE INVENTION

The present invention relates to a transmission actuator, to a transfer mechanism for the transmission actuator, to a system consisting of a transmission actuator and transfer mechanism, to a transmission having such a system, to a drive train, and to a vehicle.

The optimal use of structural space is critical in vehicle development. If, for example, a component can be designed in a more space-saving fashion, the structural space saved as a result is available either for installing other components or a housing can, for example, enclose certain components more closely.

It is customary in transmission engineering to provide a transmission actuator for setting a shifted position which is represented by a gear stage or gear of for setting a neutral position in the transmission, wherein the transmission actuator performs an actuating movement in order to do this which is imparted directly or via intermediate elements to a shift element, in particular to a shift collar, as a result of which the latter is displaced such that the desired shifted position is set. The actuating movement of the transmission actuator is here oriented parallel to the transmission shaft axis, which has the consequence that the transmission actuator also extends essentially parallel to the transmission shaft axis. The problem here is that there is free structural space between the outer contour of the gear stages, i.e. for example between the external diameter of the gear wheels on the transmission shaft, and the transmission actuator.

A parallel arrangement of the actuating movement and the transmission shaft axis can, in particular in the case of short transmissions or in the case of transmissions with an upward- or downward-sloping housing geometry, have disadvantages in terms of structural space and in terms of mechanical support with regard to vibrations.

The object of the present invention is thus to demonstrate options for saving this structural space.

This object is achieved by the subjects of the independent claims. Advantageous developments are the subject of the dependent claims.

According to the invention, a transmission actuator for setting at least one shifted position in a transmission, which has at least one transmission shaft, is provided, wherein the transmission actuator is designed to perform an actuating movement in an actuating direction in order to set the shifted position, wherein a characteristic direction of orientation of the transmission actuator is oriented non-parallel relative to the transmission shaft axis of the at least one transmission shaft.

The characteristic direction of orientation is preferably a main direction of extent of the transmission actuator in which the maximum extent of the transmission actuator runs relative to the extents of the transmission actuator in the other two spatial directions. If the transmission actuator is, for example, 100 mm wide, 70 mm deep, and 200 mm long, the direction of extent in which the length of the transmission actuator extends is the main direction of extent or the characteristic direction of orientation. Alternatively or additionally, the characteristic direction of orientation can be the actuating direction of the transmission actuator.

The transmission actuator accordingly preferably has a design which allows the transmission actuator to be mounted in or on the transmission such that its main direction of extent and/or its actuating direction are/is oriented non-parallel to the transmission shaft axis. In particular, the transmission actuator can be designed for mounting by means of fastening means such as, for example, screws.

The main direction of extent and the actuating direction of the transmission actuator are parallel to each other or identical to each other.

The characteristic direction of orientation of the transmission actuator and the transmission shaft axis of the at least one transmission shaft are preferably oriented relative to each other such that they intersect at an angle. Alternatively, a skewed orientation of the characteristic direction of orientation of the transmission actuator and the transmission shaft axis can also be provided.

The transmission actuator can preferably be activated hydraulically, pneumatically, electrically, magnetically, and/or mechanically. The actuating movement is here preferably designed to be translational. In the case of hydraulic or pneumatic activation, a piston, which is moved by a hydraulic or pneumatic pressure, is preferably provided in order to perform the actuating movement. Mechanical activation can in particular be implemented by a combination of a rack and pinion, by a worm gear, or by a ball screw. In the case of electrical or magnetic activation, the required force is generated by electrical or magnetic fields. Lastly, different principles can also be combined. Thus, for example, an electric motor can drive a ball screw, as a result of which an actuating movement is produced mechanically.

The characteristic direction of orientation, in particular the actuating direction and/or the main direction of extent, is preferably arranged essentially parallel to a tangent to the outer contour of two gear stages, wherein the two gear stages are preferably arranged on the same transmission shaft. It is thus obtained that the transmission actuator can be oriented so that it corresponds to the outer contour of the gear stages, as a result of which in particular the desired saving in structural space is achieved. The gear stages are, for example, formed by gear wheel stages. The outermost dimension of the gear stages can be considered as the outer contour. In the case of a gear wheel stage, this corresponds to the external or tip diameter of the gear wheel.

According to the invention, a transfer mechanism for transferring an actuating movement, in particular of a transmission actuator as described above, is provided which has a first coupling point which is designed to come into contact with the transmission actuator and to receive its actuating movement, and which has a second coupling point which is designed to come into contact with a shift element of a transmission, in particular with a shift collar, wherein the transfer mechanism is designed so as to convert the actuating movement into a shifting movement which causes a shifted position in the transmission to be set. It can thus advantageously be achieved that the straight-line actuating movement of the transmission actuator does not need to be converted parallel to the shifting movement of the shift element. Instead, the possibility is now created of providing the transmission actuator at a different orientation in the transmission. The transfer mechanism can, however, also be designed to be suitable for converting an actuating movement which is oriented parallel to the transmission shaft axis into a shifting movement.

The term “coupling point” is understood in this application to mean in particular a location or an element of the transfer mechanism via which the actuating movement can be imparted to the transfer mechanism or via which the shifting movement can be provided. The coupling points therefore represent interfaces via which the transfer mechanism can come into contact with the transmission actuator or with the shift element. These interfaces can have different designs, as shown by way of example further below.

The transfer mechanism preferably has a transfer element which is designed to convert the actuating movement into the shifting movement. The transfer element can be designed, for example, as a rod or have a rod.

The transfer element is preferably designed to effect translation of the actuating movement into the shifting movement. Both gearing up and gearing down can be provided here. A 1:1 gear ratio is also conceivable such that the actuating movement corresponds to a movement which covers a distance of the same length as the shifting movement resulting therefrom. In the case of gearing down, i.e. when the actuating movement covers a longer distance than the shifting movement resulting therefrom, it is advantageous that the transmission actuator which performs the actuating movement can be designed to be smaller or less powerful than an embodiment with gearing up because the force which is applied to the shift element by the transmission actuator via the transfer mechanism is simultaneously increased. In the case of gearing up, it is in turn advantageous if the distance covered by the actuating movement is smaller than the distance of the shifting movement. As a result, less structural space needs to be provided for the transmission actuator or for the actuating movement thereof.

The transfer element is preferably mounted rotatably and designed to generate a shifting movement by the actuating movement by means of rotation. The transfer element is here preferably rotatably mounted in a pivot point which is situated between the coupling points. The gear ratio can thus be determined by the respective spacings between the pivot point and the respective coupling points, wherein further influences such as, for example, a contact surface pairing or length adjustment, as described below, can further influence the gear ratio.

The pivot point is preferably provided on the transmission actuator or integrated into the transmission actuator such that the transmission actuator and the transfer element form an integral unit which can be mounted correspondingly simply directly on the transmission, wherein during the mounting the transfer element particularly preferably directly establishes a mechanical connection with the shift element (for example, by engaging in a shift collar).

The transfer element can be designed specifically as a shift fork or have a shift fork in addition to further elements. The shift fork is preferably designed so as to be connected to the shift element in the second coupling point in order to impart the shifting movement to it.

The transfer element is preferably designed so that it can be displaced in translation, in particular can be displaced in parallel with respect to the transmission shaft axis, in order to effect the conversion of the actuating movement into the shifting movement. The ability to be displaced in translation can be provided as an alternative or in addition to the rotatable mounting of the transfer element. In the case of the additional ability to be displaced, a complex movement of the transfer element in combination with the rotatable mounting is also possible in order to translate the actuating movement into a shifting movement.

The transfer mechanism preferably has a length adjustment mechanism which is designed to carry out a length adjustment between the coupling points when the actuating movement is applied. Because the actuating movement is not oriented parallel to the transmission shaft axis, a length adjustment must be carried out between the coupling points. This length adjustment mechanism can be designed in different ways. If the connection of the transmission actuator or the shift element is implemented in the respective coupling point by means of a bearing which permits rotational movement between the transmission actuator or the shift element and the transfer mechanism, a length adjustment must be carried out between the two coupling points. The same also applies when the connection does not permit a rotational movement in the coupling points. The length adjustment mechanism is preferably designed as part of the transfer element. A rolling or plain bearing can, for example, be provided as the bearing.

The length adjustment mechanism preferably has an elastic pretension which acts between the coupling points. This elastic pretension can preferably be generated by a spring. The elastic pretension preferably causes the length adjustment mechanism to have a force constantly applied to it such that the transfer element constantly attempts to expand between the coupling points.

According to the invention, a system is provided which has a transmission actuator, as described above, and a transfer mechanism, as described above, wherein the transmission actuator is connected to the transfer mechanism via the first coupling point in order to impart the actuating movement to the transfer mechanism.

The transfer mechanism has a transfer element which can rotate about a pivot point and this pivot point is thus preferably provided on the transmission actuator or integrated into the latter, as already explained above.

The connection between the transmission actuator and the transfer mechanism in the first coupling point is preferably designed to be non-rotatable. Alternatively or additionally, this connection can also be designed as integral, i.e. in the first coupling point, an element of the transfer mechanism, preferably the element which transfers the shifting movement to the shift element, and the element of the transmission actuator which performs the actuating movement are designed as one component.

Alternatively, the connection between the transmission actuator and the transfer mechanism in the first coupling point can also be designed to be rotatable or have a contact surface pairing. A rotatable design can in particular be obtained by a plain or rolling bearing via which the transfer mechanism, preferably the transfer element of the latter, and the element which carries out the actuating movement are connected. In the case of a contact surface pairing, the connection between the transfer mechanism, preferably the transfer element, and the element of the transmission actuator which carries out the actuating movement consists of contact between the two elements. These are designed such that they abut each other only such that the actuating movement can be imparted to the transfer mechanism. To do this, contact surfaces are formed on both elements. In particular in the case of a rotatably provided transfer element or in order to implement a length adjustment, the contact surface pairing can be designed such that the two contact surfaces roll and/or slide on each other when in contact and/or perform a relative movement relative to each other in order to produce the rotational movement or the length adjustment.

According to the invention, a transmission is provided which has a system, as described above, and a shift element, in particular a shift collar. The shift element is here designed to carry out a shifting movement in order to set a shifted position in the transmission. The shift element is here connected to the transfer mechanism via the second coupling point in order to impart the shifting movement to the shift element.

The transmission actuator is preferably arranged in the transmission such that a characteristic direction of orientation of the transmission actuator, as described above, is arranged non-parallel to a transmission shaft axis. Particularly preferably, the characteristic direction of orientation, in particular the actuating direction and/or the main direction of extent, is arranged essentially parallel to a tangent to the outer contour of two gear stages, wherein the two gear stages are preferably arranged on the same transmission shaft.

The connection between the shift element and the transfer mechanism in the second coupling point is preferably designed to be non-rotatable. Alternatively or additionally, this connection can also be designed as integral, i.e. in the second coupling point, an element of the transfer mechanism, preferably the element to which the actuating movement of the transmission actuator is imparted, and the shift element are designed as one component.

Alternatively, the connection between the shift element and the transfer mechanism in the second coupling point can be designed to be rotatable or have a contact surface pairing. A rotatable design can in particular be obtained by a plain or rolling bearing via which the transfer mechanism, preferably the transfer element of the latter, and the shift element are connected. In the case of a contact surface pairing, the connection between the transfer mechanism, preferably the transfer element, and the shift element consists of contact of the two elements. These are designed such that they abut each other only such that the shifting movement can be imparted to the shift element. To do this, contact surfaces are formed on both elements. In particular in the case of a rotatably provided transfer element or in order to implement a length adjustment, the contact surface pairing can be designed such that the two contact surfaces roll and/or slide on each other when in contact and/or perform a relative movement relative to each other in order to produce the rotational movement or the length adjustment.

According to the invention, a drive train for a vehicle is provided which has a transmission as described above.

The subjects according to the invention shown here are preferably designed to be provided in an electric- or hybrid-drive vehicle. Alternatively or additionally, the subjects according to the invention shown here are designed to be provided in a commercial vehicle.

According to the invention, a vehicle is provided which has a transmission, as described above, or a drive train, as described above. The vehicle is preferably an electric- or hybrid-drive one and/or designed as a commercial vehicle.

The invention is not limited to the above-described embodiments. Instead, further embodiments can be obtained by individual features being combined with one another, replaced by others, or omitted.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a first embodiment of the invention; and

FIG. 2 shows a second embodiment of the invention.

### DETAILED DESCRIPTION

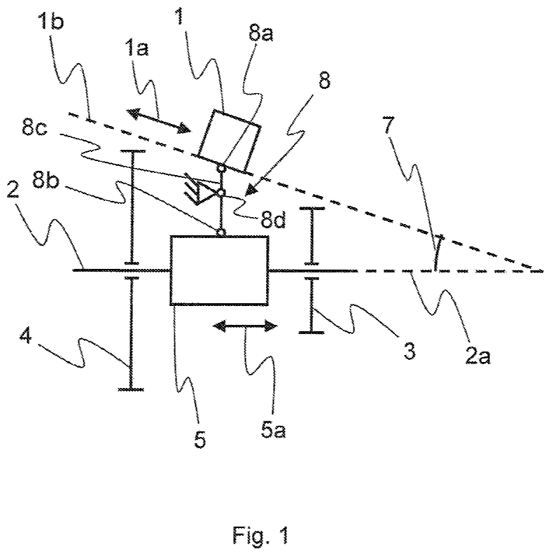

FIG. 1 shows a first embodiment of the invention. An arrangement in principle of a transmission actuator 1, a transfer mechanism 8, and a transmission shaft 2 is shown in a view in section.

The transmission actuator 1 is designed to carry out an actuating movement 1a which is illustrated in the drawings by the double-headed arrow as a translational movement. The actuating movement 1a can thus be performed parallel to an actuating direction 1b which is indicated in the drawings by a dashed line. The actuating direction 1b is inclined relative to the transmission shaft axis 2 by an angle of inclination 7 such that the actuating direction 1b and the transmission shaft axis 2a are oriented non-parallel to each other. In the embodiment shown, the actuating direction 1b corresponds to the characteristic direction of orientation of the transmission actuator 1, as described above.

The transmission shaft 2, the transmission shaft axis 2a of which is oriented horizontally from left to right, has a first gear wheel 3 and a second gear wheel 4 which are provided rotatably on the transmission shaft 2. Both gear wheels 3, 4 have different radii and thus form different gear stages. A shift element 5 in the form of a shift collar is furthermore provided between the gear wheels 3, 4 on the transmission shaft 2. This shift element 5 is designed so as to be displaceable in a shifting movement 5a which is here oriented parallel to the transmission shaft axis 2a as a translational movement. The shift element 5 is provided to be non-rotatable about the transmission shaft axis 2a on the transmission shaft 2.

The arrangement shown here of the transmission shaft 2, gear wheels 3, 4, and shift element 5 corresponds to an arrangement that is known in transmission engineering. In order to set a shifted position, for example via the gear stage which is represented by the first gear wheel 3, the shift element 5 is moved to the right in accordance with a shifting movement 5a. The shift element 5 here comes into contact with the first gear wheel 3 and forms a non-rotatable connection about the transmission shaft axis 2a such that the first gear wheel 3 is then connected non-rotatably to the transmission shaft 2 via the shift element 5. The shifted position which is represented by the second gear wheel 4 is similarly set by a shifting movement 5a of the shift element to the left.

In the arrangement shown, the actuating direction 1b is oriented according to the outer contour of the gear stages of the transmission shaft 2. Specifically, this means that the actuating direction 1b is oriented parallel to a tangent to the gear wheels 3, 4. In general, such an orientation can also be parallel to a three-dimensional envelope of the gear stages.

A transfer mechanism 8 is furthermore provided to transfer the actuating movement 1a to the shift element 5 such that the shift element 5 can perform the shifting movement 5a. The transfer mechanism 8 has a first coupling point 8a via which the transmission actuator 1 is coupled to the transfer mechanism 8. The transfer mechanism 8 has a further second coupling point via which the shift element 5 is coupled to the transfer mechanism 8.

The transfer mechanism 8 moreover has a transfer element 8c which is provided rotatably about a pivot point 8d and is designed so as to translate the actuating movement 1a which is imparted to the first coupling point 8a into the shifting movement 5a.

The connection of the transmission actuator 1 and the shift element 5 can be configured differently in the coupling points 8a, 8b.

In an embodiment, at least one connection can be designed to be articulated in one of the two coupling points 8a, 8b such that the transfer element 8c can rotate about the first coupling point 8a relative to the transmission actuator 1 and/or about the second coupling point 8b relative to the shift element 5. It can, for example, be provided here that a bearing, in particular a plain or rolling bearing, is provided in the corresponding coupling point 8a, 8b. In the case of such a connection, that part of the transfer element 8c which is connected to the corresponding coupling point 8a, 8b does not need to constantly follow the bearing. Therefore, because of the non-parallel orientation of the transmission shaft axis 2a relative to the movement direction 1b by the angle 7, when the transfer mechanism 8 moves in rotation about the pivot point 8d, a length adjustment must be carried out in order to reposition the first coupling point 8a to be parallel to the actuating direction 1b and the second coupling point 8b to be parallel to the transmission shaft axis 2a. To do this, the transfer mechanism 8 has a length adjustment mechanism (not shown) which is designed to carry out the length adjustment between the two coupling points 8a, 8b.

The length adjustment mechanism can take the form, for example, of a transfer element 8c which is designed such that its extent can be modified between the coupling points 8a, 8b. When the transfer element 8c is moved in rotation, it is thus ensured that the transfer element 8c can follow the changing gap between the coupling points 8a, 8b.

The length adjustment mechanism can furthermore have an elastic pretensioning force which can be applied, for example, by a spring. The elastic pretensioning force is here oriented such that it acts between the coupling points 8a, 8b and is oriented such that it acts constantly in the direction of extent of the transfer element 8c. In this way, a change in the length of the rod can be assisted by the elastic pretensioning force such that the length adjustment can take place reliably.

In a specific embodiment, a length adjustment mechanism can have a transfer element 8c in the form of a rod which is attached rotatably by means of plain or rolling bearings to the transmission actuator 1 or the shift element 5 with its ends in the coupling points 8a, 8b. The rod thus extends between the coupling points 8a, 8b. A spring is furthermore provided, the elastic pretensioning force of which acts between the coupling points 8a, 8b and causes the rod to constantly maximize its extent between the coupling points 8a, 8b.

The connection of the transfer element 8c in at least one of the coupling points 8a, 8b can, however, also be designed as a rolling and/or sliding coupling. For this purpose, a contact surface pairing (not shown), via which the transfer element 8c is in contact with the transmission actuator 1 and/or with the shift element 5, is formed in at least one of the coupling points 8a, 8b. The actuating movement 1b of the transmission actuator 1 can then be transferred via the contact surface pairing in the first coupling point 8a to the transfer element 8c, wherein one contact surface is formed on the transmission actuator 1 and the other contact surface is formed on the transfer element 8c. In the same way, a rotational movement of the transfer element 8c can also be transferred to the shift element 5. A contact surface pairing can be provided here too in the second coupling point 8b, wherein one contact surface is formed on the shift element 5 and the other contact surface is formed on the transfer element 8c. The respective contact surfaces in the contact surface pairings are designed in order to roll and/or slide on each other. For this purpose, at least one contact surface can be designed to be curved. When the transfer element 8c rotates about the pivot point 8d, the contact surfaces roll and/or slide in the corresponding contact surface pairings. By virtue of the rolling and/or sliding action, the contact point between the contact surfaces can here move around within the contact surface pairing. It is therefore not absolutely essential here for length adjustment to be provided because this is implemented by the moving contact point.

The connection of the transfer element 8c in at least one of the coupling points 8a, 8b to the transmission actuator 1 and/or to the shift element 5 can also be designed as integral, i.e. an element of the transmission actuator 1 which performs the actuating movement 1a is designed to be integral with the transfer element 8c in the first coupling point 8a. Alternatively or additionally, the shift element 5 can also be designed to be integral with the transfer element 8c in the second coupling point 8b.

The transmission actuator 1 can, depending on the embodiment, be activated in particular hydraulically, pneumatically, electrically, magnetically, and/or mechanically.

The functioning of the arrangement shown is as follows:

First, the arrangement is arranged as illustrated. The shift element 5 is situated between the gear wheels 3, 4. The arrangement is thus situated in the neutral position. In order to set a shifted position which is represented by the first gear wheel 3, the transmission actuator 1 performs an actuating movement 1a in the actuating direction 1b in the drawings to the left and upward. As a result, the first coupling point 8a is moved in the actuating direction 1b to the left and upward, as a result of which the transfer element 8c is rotated about the pivot point 8d in a counterclockwise direction. As a result, the second coupling point 8b and hence the shift element 5 are furthermore moved in a shifting movement 5a to the right and parallel to the transmission shaft axis 2a. This continues until the shift element 5 abuts the first gear wheel 3, as a result of which, as described above, the desired shifted position is set. A different shifted position, namely the one represented by the second gear wheel 4, or the neutral position, is set in a similar fashion by a corresponding actuating movement 1a of the transmission actuator 1 to the right and downward or back into the position shown in FIG. 1.

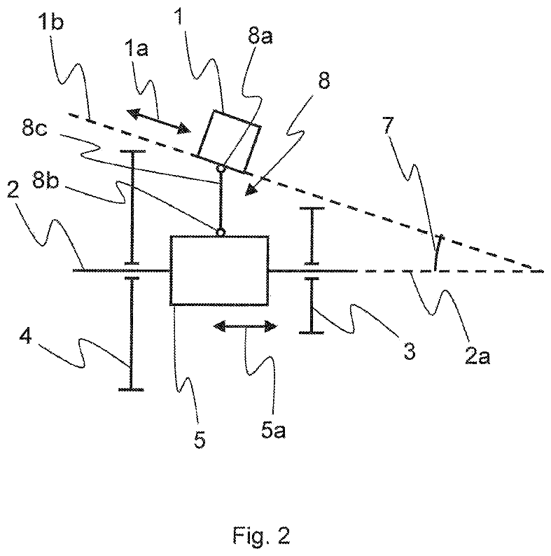

FIG. 2 shows a second embodiment of the invention. Here too, an arrangement of a transmission actuator 1, a transfer mechanism 8, and a transmission shaft 2 is shown in a view in section. The embodiment shown here differs from that in FIG. 1 in a different design of the transfer mechanism 8. The transmission actuator 1 and the transmission shaft 2 are identical to those in FIG. 1. Reference should therefore be made to the embodiment in FIG. 1 for an explanation thereof.

Here too, the actuating direction 1b of the transmission actuator 1 corresponds to the characteristic direction of orientation of the transmission actuator 1.

The transfer mechanism 8 here has a transfer element 8c which is connected to the transmission actuator 1 in a first coupling point 8a and to the shift element 5 in a second coupling point 8b. In contrast to the embodiment which is shown in FIG. 1, the transfer element 8c is here not mounted rotatably. Instead, it is provided so that it can be displaced relative to the transmission shaft axis 2a. This can be implemented, for example, by a guide (not shown) which guides the transfer element 8c parallel to the transmission shaft axis 2a. The guide can furthermore be designed so as to guide the transfer element 8c in such a way that rotation thereof, with an axis of orientation oriented perpendicular to the plane of the drawing, is prevented.

The connection in the coupling points 8a, 8b between the transfer element 8c and the transmission actuator 1 or the shift element 5 can here be designed in the same way as in the embodiment in FIG. 1. Rotatable, non-rotatable, integral designs and/or contact surface pairings can thus be provided, as were described above with reference to FIG. 1.

When an actuating movement is carried out by the transmission actuator 1, here too a length adjustment mechanism (not shown) must be provided between the coupling points 8a, 8b in order to carry out a length adjustment. This too can be designed as described with reference to FIG. 1.

The functioning of the arrangement shown is as follows:

First, the arrangement is arranged as illustrated. The shift element 5 is situated between the gear wheels 3, 4. The arrangement is thus situated in the neutral position. In order to set a shifted position which is represented by the first gear wheel 3, the transmission actuator 1 performs an actuating movement 1a in the actuating direction 1b in the drawings to the right and downward. As a result, the first coupling point 8a is moved in the actuating direction 1b to the right and downward, as a result of which the transfer element 8c is displaced to the right. As a result, the second coupling point 8b and hence the shift element 5 are furthermore moved in a shifting movement 5a to the right and parallel to the transmission shaft axis 2a. The two coupling points 8a, 8b here move toward each other because the length adjustment mechanism permits a shortening of the transfer element 8c. The shifting movement 5a to the right continues until the shift element 5 abuts the first gear wheel 3, as a result of which, as described above, the desired shifted position is set. A different shifted position, namely the one represented by the second gear wheel 4, or the neutral position, is set in a similar fashion by a corresponding actuating movement 1a of the transmission actuator 1 to the left and upward or back into the position shown.

In addition to the embodiments shown here, further embodiments are conceivable in which the actuating direction 1b of the transmission actuator 1 is not oriented parallel to a tangent to the gear wheels 3, 4, and the actuating direction 1b can rather be oriented arbitrarily. Instead, a main direction of extent of the transmission actuator 1 can be oriented parallel to the tangent to the gear wheels 3, 4 as the characteristic direction of orientation. It is thus ensured that the transmission actuator 1 is adapted with its largest direction of extent to the outer contour of the gear stages which are represented by the gear wheels 3, 4.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE NUMERALS

1 transmission actuator
1a actuating movement
1b actuating direction
2 transmission shaft
2a transmission shaft axis
3 first gear wheel
4 second gear wheel
5 shift element
5a shifting movement
7 angle of inclination
8 transfer mechanism
8a first coupling point
8b second coupling point
8c transfer element
8d pivot point

1-19. (canceled)

20. A transmission actuator for setting at least one shifted position in a transmission which has at least one transmission shaft, wherein
the transmission actuator is configured to perform an actuating movement in an actuating direction to set the at least one shifted position, and
the actuating direction is not parallel to a transmission shaft axis of the at least one transmission shaft.

21. The transmission actuator as claimed in claim 20, wherein
a longitudinal direction of the transmission actuator is aligned with the actuating direction.

22. The transmission actuator as claimed in claim 20, wherein
the transmission actuator is activatable one or more of hydraulically, pneumatically, electrically, magnetically, and mechanically.

23. The transmission actuator as claimed in claim 22, wherein
the actuating direction is essentially parallel to a tangent to an outer contour of two gear stages arranged on the at least one transmission shaft.

24. A transfer mechanism for transferring an actuating movement of a transmission actuator, the transmission actuator being configured to perform an actuating movement to set at least one shifted position of a transmission in an actuating direction which is not parallel to a transmission shaft axis of at least one transmission shaft,
wherein the transfer mechanism includes a first coupling point at the transmission actuator configured to receive the actuating movement and a second coupling point at a shift element of the transmission configured to convert movement of the first coupling point to the a shifting movement of a shift element to set the at least one shifted position.

25. The transfer mechanism as claimed in claim 24, wherein
the transfer mechanism includes a transfer element configured to couple the first coupling point to the second coupling point such that the actuating movement is converted into the shifting movement.

26. The transfer mechanism as claimed in claim 24, wherein
the transfer element translates the actuating movement into a shifting movement of a shift element.

27. The transfer mechanism as claimed in claim 25, wherein
the transfer element is mounted rotatably to generate the shifting movement by m rotation about a pivot point response to the actuating movement.

28. The transfer mechanism as claimed in claim 25, wherein
the transfer element is displaceable in translation parallel to the transmission shaft axis to convert the actuating movement into the shifting movement.

29. The transfer mechanism as claimed in claim 25, wherein
the transfer element includes a length adjustment mechanism configured to adjust a length between the first and second coupling points during the actuating movement.

30. The transfer mechanism as claimed in claim 29, wherein
the length adjustment mechanism is elastic pretensioned between the first and second coupling points.

31. A system, comprising:
a transfer mechanism as claimed in claim 27, wherein
the pivot point of the transfer mechanism is formed on or in the transmission actuator.

32. The system as claimed in claim 31, wherein
the connection between the transmission actuator and the transfer mechanism in the first coupling point is non-rotatable and/or integral.

33. The system as claimed in claim 31, wherein
the connection between the transmission actuator and the transfer mechanism in the first coupling point is rotatable or has a contact surface pairing.

34. A transmission, comprising:
a system as claimed in 31,
wherein
the shift element is a shift collar configured to carry out the shifting movement to set the at least one shifted position in the transmission, and
the transmission is an electric- or hybrid-drive vehicle transmission and/or a commercial vehicle transmission.

35. The transmission as claimed in claim 34, wherein
the connection between the shift collar and the transfer mechanism in the second coupling point is non-rotatable and/or integral.

36. The transmission as claimed in claim 34, wherein
the connection between the shift collar and the transfer mechanism in the second coupling point is rotatable or has a contact surface pairing.

37. A drive train for a vehicle, having a transmission as claimed in claim 34, wherein
the drive train is an electric- or hybrid-drive vehicle drive train and/or a commercial vehicle drive train.

38. A vehicle having a transmission as claimed in claim 34, wherein
the drive train is an electric- or hybrid-drive vehicle drive train and/or a commercial vehicle drive train.
